(19) United States
(12) Patent Application Publication
(10) Pub. No.: US 2021/0222329 A1
(43) Pub. Date: Jul. 22, 2021

(54) SCALABLE METHOD OF PRODUCING POLYMER-METAL NANOCOMPOSITE MATERIALS

(71) Applicant: The Regents of the University of California, Oakland, CA (US)

(72) Inventors: Xiaochun Li, Manhattan Beach, CA (US); Abdolreza Javadi, Los Angeles, CA (US); Jingzhou Zhao, Los Angeles, CA (US)

(73) Assignee: The Regents of the University of California, Oakland, CA (US)

(21) Appl. No.: 16/308,430

(22) PCT Filed: Jun. 7, 2017
(86) PCT No.: PCT/US17/36432

§ 371 Date: Dec. 7, 2018

Related U.S. Application Data
(60) Provisional application No. 62/347,382, filed on Jun. 8, 2016.

(51) Int. Cl. D01D 5/02; D01F 6/66; D01F 1/09; B29C 43/00; C08K 3/08; D01F 6/76

(52) U.S. Cl. CPC D01D 5/02; D01F 6/66; D01F 1/09; B82Y 30/00; B29C 43/006; C08K 3/08; D01F 6/76; B29C 43/003

(57) ABSTRACT

A method of forming a polymer-metal nanocomposite (PMNC) material with a substantially uniform dispersion of metal particles includes forming a composite solid preform by mixing a blend of micrometer-sized metal particles and polymer particles and subjecting the mixture to compression followed by sintering. The composite solid preform is drawn through a heated zone to form a reduced size fiber. The reduced size fiber is cut into segments and a next preform is formed using the bundle of the segments. The next preform is then drawn through the heated zone to form yet another reduced size fiber. This reduced size fiber may undergo one or more stack-and-draw operations to yield a final fiber having substantially uniform dispersion of nanometer-sized metal particles therein.

### RELATED APPLICATION

This application claims priority to U.S. Provisional Patent Application No. 62/347,382 filed on Jun. 8, 2016, which is hereby incorporated by reference in its entirety. Priority is claimed pursuant to 35 U.S.C. § 119 and any other applicable statute.

### STATEMENT REGARDING FEDERALLY SPONSORED RESEARCH AND DEVELOPMENT

This invention was made with Government support under 1449395, awarded by the National Science Foundation. The Government has certain rights in the invention.

### TECHNICAL FIELD

The technical field generally relates to methods of manufacturing polymer-metal nanocomposites (PMNCs) with uniform dispersion of metal nanoparticles in a polymer matrix.

### BACKGROUND

PMNCs have drawn significant attention in the past two decades due to their unique physicochemical properties for functional applications, including, but not limited to, electrically conducting polymers for transparent electrodes, electromagnetic interface shielding (e.g., electromagnetic interference shielding), electrostatic dissipation, plasmonic metamaterials as electromagnetic wave absorbers for solar cells, and antimicrobial polymers. Based on the nature of the incorporation of metal nanoparticles, the fabrication methods can be divided into so-called extrinsic and intrinsic methods. For extrinsic methods, nanoparticles are prepared separately and then incorporated into the polymer matrix during processing. Nanoparticles are dispersed via some kinetic approaches such as using shear forces or ultrasonic vibrations. The surface of the metal nanoparticles are often functionalized or passivated to facilitate dispersion. A uniform dispersion of dense nanoparticles, however, is still hard to achieve. Nanoparticles tend to aggregate into larger particles due to Van der Waals attractive forces. Bulk manufacturing processes that incorporate nanoparticles directly into products have serious safety drawbacks because the small nanoparticles can rapidly combust given appropriate ignition conditions.

In contrast, extrinsic methods utilize physical deposition to produce polymer-metal nanocomposites. Unfortunately, these deposition methods generally offer a homogeneous distribution only in thin films. The intrinsic methods are basically of chemical nature as metal particles are formed in-situ during processing. These wet chemical methods, which are generally very complex, can only produce a very limited set of bulk polymer-metal nanocomposites with a reasonable dispersion of metal nanoparticles.

Thermal fiber drawing processes have recently emerged as a novel top-down nano-manufacturing process. Nano-wires of semiconductor, some amorphous metals, and polymers embedded in amorphous cladding materials, such as fused silica, Pyrex® glass and thermoplastic polymers, have been demonstrated. For example, International Patent Publication No. WO 2016/122958 discloses a method for thermally drawing fibers that contain continuous crystalline metal nanowires. However, due to the low viscosity and high surface tension of the molten metal, it is extremely difficult to obtain nanoscale metal threads/wires in the amorphous cladding (such as polymers). A scalable fabrication technique for forming polymer nanocomposites with a uniform dispersion of dense, crystalized metal nanoparticles remains a long-standing challenge.

### SUMMARY

In one embodiment, a method of forming a polymer-metal nanocomposite (PMNCs) material with a substantially uniform dispersion of metal particles in a polymer matrix includes the steps of forming a solid composite preform by mixing a blend of micrometer-sized metal particles and mixture of polymer particles and subjecting the mixture to compression followed by sintering. The composite, solid preform is then drawn through a heated zone to form a reduced size fiber. This reduced size fiber is cut into a plurality of fiber segments and a second composite preform is formed by stacking or bundling the fibers and placing the bundle in a cladding or jacket made from a polymer (which may be the same polymer material used for the polymer particles). The second composite preform is then drawn through the heated zone to form another reduced sized fiber. A third composite preform can be made in the same manner described above and then drawn through the heated zone to form yet another reduced size fiber. After the third drawing cycle, the metal particles contained in the fiber are typically nanometer sized and more uniformly dispersed within the polymer matrix. In some embodiments, however, additional cycles of the stack-and-draw process may be needed to form nanometer-sized metal particles that are uniformly dispersed in the polymer matrix. In other embodiments, only two cycles of thermal drawing are needed.

In another embodiment, a method of forming a polymer-metal nanocomposite (PMNC) material with a substantially uniform dispersion of metal particles includes: (a) forming a composite solid preform by mixing a blend of micrometer-sized metal particles and polymer particles and subjecting the mixture to compression followed by sintering; (b) drawing the composite solid preform of (a) through a heated zone to form a reduced size fiber; (c) cutting the reduced size fiber into segments and forming a next preform using the bundle of the segments; and (d) drawing the next preform through the heated zone to form a reduced fiber. Operations (c) and (d) may be repeated a plurality of times to form the final fiber.

In another embodiment, a method of forming a molded polymer-metal nanocomposite material with a substantially uniform dispersion of metal particles includes forming a blend of metal particles having a size range from 1 μm to several millimeters and polymer particles, wherein the metal particles have a melting temperature less than a decomposition temperature of the polymer. The metal and polymer blend is then subject injection molding to generate the molded polymer-metal nanocomposite material, wherein the molded polymer-metal nanocomposite material has a substantially uniform dispersion of metal particles having sizes less than 1 μm.

In another embodiment, a fiber that is created using the process described herein may be used to manufacture other structures. For example, the fiber can be woven to generate useful articles of manufacture.

### BRIEF DESCRIPTION OF THE DRAWINGS

FIG. 1A is a flow chart illustrate one embodiment of thermally drawing a fiber that includes nanometer sized metal particles in a polymer matrix.

FIG. 1B illustrates a schematic view of a cross-section of a thermally pulled fiber.

FIG. 2 is a schematic illustration of a process for making a composite preform according to one embodiment for use in a thermal drawing process.

FIG. 3 illustrates a process whereby a metal-polymer composite preform is being thermally drawn in a first cycle.

FIG. 4 illustrates a stack-and-draw process iterative process that is used to generate nanometer sized metal particles in a polymer matrix. This process may be repeated a plurality of times.

FIG. 5 illustrates an injection molding system that may be used in connection with the mixture of metal particles and polymer particles.

FIG. 6A is an optical microscope image from a longitudinal cross-section of PES-5Sn composite preform.

FIG. 6B is a graph of the size distribution of Sn microparticles in the PES-5Sn composite preform.

FIG. 7A illustrates a schematic of a nanocomposite fiber/film (after the third cycle of thermal drawing) attached to a carbon tape that itself is attached to a stub of the scanning electron microscope (SEM).

FIG. 7B is a SEM image taken from the thin films prepared by the ultramicrotome tool.

FIG. 7C is a SEM image taken from the thin films prepared by the ultramicrotome tool. FIG. 7C is a magnified view of the square region in FIG. 7B.

FIG. 8 illustrates a graph of the size distribution of the Sn nanoparticles in the nanocomposite fiber after the third cycle of thermal drawing. Note the smaller particle size and more uniform size distribution of particles.

### DETAILED DESCRIPTION OF THE ILLUSTRATED EMBODIMENTS

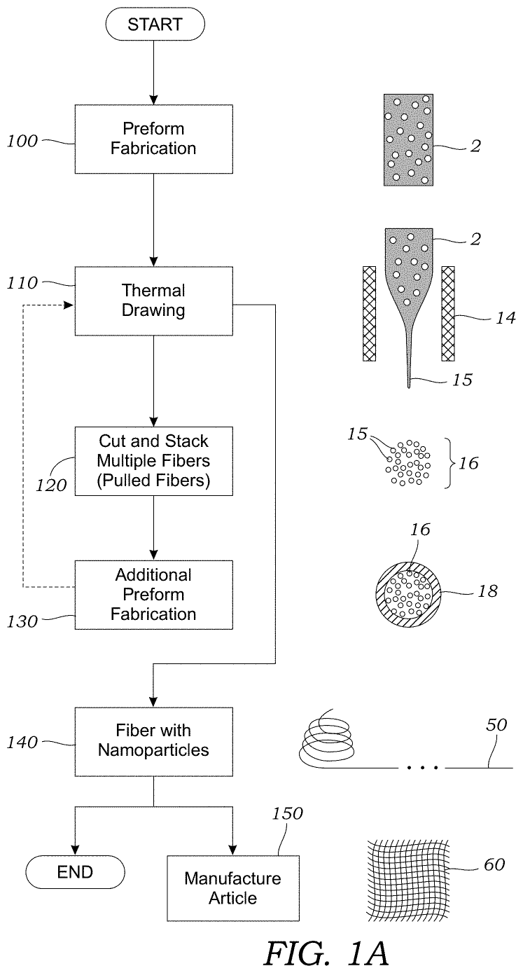

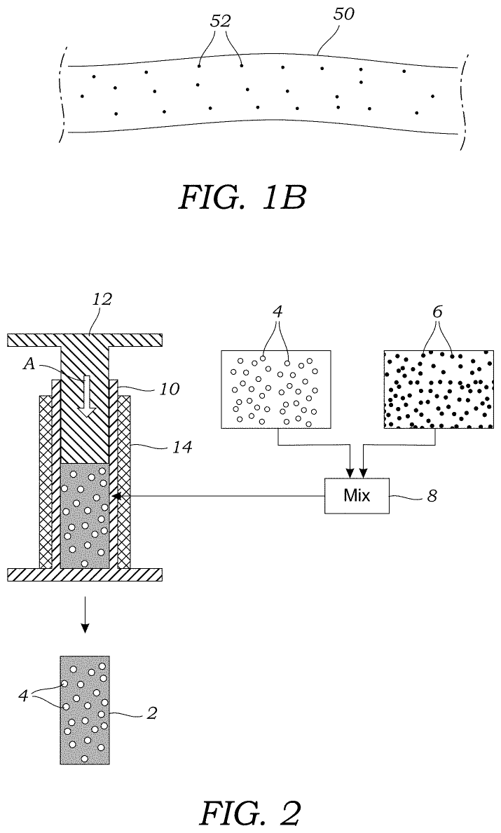

FIG. 1A illustrate a flowchart illustrating one illustrative method of thermally drawing a fiber 50 containing uniformly dispersed, nanometer sized metal particles 52 (seen in FIG. 1B). The nanometer sized metal particles 52 are dispersed in a substantially uniform manner in the fiber 50. FIG. 1B illustrates a cross-sectional view of the fiber 50 with the nanometer sized metal particles 52. Referring to FIG. 1A, the method starts with operation 100 where a solid preform 2 is fabricated. In this embodiment, the preform 2 is first created by blending a mixture containing metal particles 4 and polymer particles 6 as seen in FIG. 2 and subjecting the same to high pressure followed by sintering. The metal particles 4 have a size (e.g., diameter or longest dimension) that, in one embodiment, is greater than 1 μm and up to several millimeters. The metal particles 4 can have any number of shapes. These could be, for illustration and not limitation, rods, spheres, tubes, disks, cubes, plates, flakes, short length fibers, whiskers, and the like. The metal particles 4 may, in some embodiments, have a core-shell structure with the core made of one material and the outer shell made from another material. The size distribution of the metal particles 4 may be non-uniform, e.g., random. The metal particles 4 may include metals or alloys of metals. The metals should have a relatively low melting temperature that is less than the degradation temperature of the polymer material that is used to form the matrix (i.e., the polymer particles 6). Typically, this temperature is less than 500° C. and more commonly less than 400° C. Tin (Sn), for example, has a low melting temperature. Other metals with low temperature melting points include bismuth (Bi) and indium (In). Still other metals with higher temperatures such as gold (Au), copper (Cu), zinc (Zn), lithium (Li), thallium (Tl), cadmium (Cd), and lead (Pb) can be formed as an alloy which has a lower melting temperature than the base metal. Additional examples of alloys include, for instance, Au—Sn, Au—Zn, Cu—Zn, Cu—Mg, Al—Cu, Zn—Mg—Al, Zn—Mg, Zn—Al, Al—Mg, Bi—Pb—Sn, Bi—Pb—Cd—Sn, Bi—Pb—In—Sn, Bi—In—Sn, In—Bi, Bi—Sn—Cd, Bi—Pb, Bi—Sn, and Sn—Zn.

The polymer particles 6 may be made from any number of thermoplastic polymer materials. The polymer particles 6 may be in the form of granules, pellets, or the like that are commercially available and may include any number of sizes and shapes. Particular examples of polymer types include, for example, polyethersulfone (PES), polysulfone (PSU), and polyethylenimine (PEI). Polymers may also include glass (e.g., Pyrex® glass) or fused silica. As explained herein, the polymer material used for the particles 6 forms a matrix that contains the reduced size metal particles 4 that are created during the thermal drawing process. The material combination of the metal particles 4 and the polymer particles 6 is chosen such that the metal particles 4 have a melting temperature that is below the degradation temperature of the polymer particles 6. The degradation temperature of the polymer particles 6 is the temperature at which the polymer begins to break down chemically or char in response to applied heat. The relative composition of metal used to form the preform 2 may vary. Typically, the mixture used to make the solid preform 2 will have less than 40% by volume of metal particles 4.

With reference to FIG. 2, the preform 2 is made by first mixing the metal particles 4 and the polymer particles 6 to form a blended mixture. This may be accomplished by subjecting the mixture to mechanical shaking in a mechanical shaker 8 for a period of time (e.g., about one hour). The well-blended mixture is then added to a mold 10 (e.g., stainless steel) and subject to compression (in the direction of arrow A) using a hydraulic press 12 as illustrated in FIG. 2. This compression may take place at room temperature. Next, the pressed mixture is then subject to sintering by exposing the compressed mixture to elevated temperatures using heater 14 (e.g., several hundred ° C.) for a period of time (e.g., about one hour) to form a solid preform 2 that will be used in the next steps.

Referring back to FIG. 1, the preform 2 is then subject to thermal drawing in operation 110. The thermal drawing operation 110 involves pulling a generated or reduced thickness fiber 15 through a furnace 14. The furnace 14 is part of a fiber drawing furnace which is well known and commercially available. The fiber drawing furnace 14 applies heat to the preform 2. The preform 2 is typically loaded above the fiber drawing furnace 14 and upon insertion the preform 2 necks down on its own and the preform 2 end is cutaway and fixed to a fiber drawing mechanism (e.g., spool, wheel or the like). The fiber drawing furnace 14 enables one to control the temperature which is set at a designated value above the softening temperature of the preform 2. The speed of the downward linear motion may be controlled by the speed of the fiber drawing mechanism (e.g., the rotational speed of the spool or wheel that accepts the fiber). The diameter (or other dimension) of the pulled fiber 15 may be monitored during fiber formation. For example, a load cell may be used as part of the fiber drawing furnace 14 to measure and monitor the drawing force which is an indicator of fiber quality and processing condition because it is directly related to the viscosity of the softened material at the neck-down area. Tension monitoring can be incorporated into the system (along with measured diameter) and used as a feedback signal to adjust or modulate the drawing/feeding speed and temperature of the furnace 14.

Next, as seen in operation 120, the reduced diameter fiber 15 that has been drawn through the furnace 14 is then cut and placed in a bundle or stack 16. This bundle 16 of fibers 15 is then used to create an additional preform 2 as illustrated in operation 130 of FIG. 1. The process involves placing the bundle 16 of fibers 15 into a jacket 18 of cladding material. The cladding material of the jacket 18 is typically made of the same polymer material as the polymer particles 6 although other polymer materials may be used. The jacket 18 may include, for example, a cylindrical jacket 18 that is already formed. Alternatively, the jacket 18 may be formed by rolling or wrapping a flat jacket 18 around the bundle 16 of fibers 15. The jacketed material is then subject to a consolidation process where the bundle 16 of fibers 15 with the jacket 18 is heated in a tube furnace (separate from the fiber drawing furnace 14) that is conventionally known. The consolidation process heats the fibers 15 and cladding material of the jacket 18 to form a unitary preform structure 2 than can then be used in another thermal drawing process as illustrated in FIG. 1A.

As seen in FIG. 1A, the preform structure 2 that is created in operation 130 can then be subject to another thermal drawing operation 110. The pulled fiber may either be a final fiber 50 which is created as seen in operation 140 or a reduced diameter fiber 15 that will be subject to additional processing. For example, typically, there will be several rounds or cycles of thermal drawing 110 followed by the cut-and-stack operation 120 followed by preform fabrication 130. This cycle of thermal drawing 110 followed by the generation of additional preforms 2 may happen a plurality of times as indicated by the flow of operations in FIG. 1A. FIG. 4 also illustrates a stack-and-draw cycle whereby the fibers 15 are stacked in a bundle 16 and consolidated inside a jacket 18 of cladding which is then subject to thermal drawing 110.

Eventually, a final fiber 50 is produced that has the desired properties as seen in operation 140. In one particular preferred embodiment, the final fiber 50 that is generated is formed with metal particles 4 formed therein of reduced diameter than those used in the initial preform 2. For instance, the final fiber 50 contains metal particles 4 that have diameters that are less than 1 μm in size (i.e., nanoparticles of metal) even though the starting preform 2 had metal particles 4 that were larger than 1 μm. In addition, the metal particles 4 are preferably dispersed in a substantially uniform manner through the polymer matrix of the final fiber 50. As seen in FIG. 1A, the final fiber 50 is produced by at least two (2) thermal drawing operations 110 although more than two cycles may be used to generate the final fiber 50.

As seen in FIG. 1A, the final fiber 50 that is formed may then itself be the final product of the manufacturing process described herein. Alternatively, the final fiber 50 may be used to generate an article of manufacture 60 as seen in operation 150. For example, a weaving operation or other known method used for fibers can generate a final article of manufacture 60. The article of manufacture 60 may include any number of geometrical shapes and configurations.

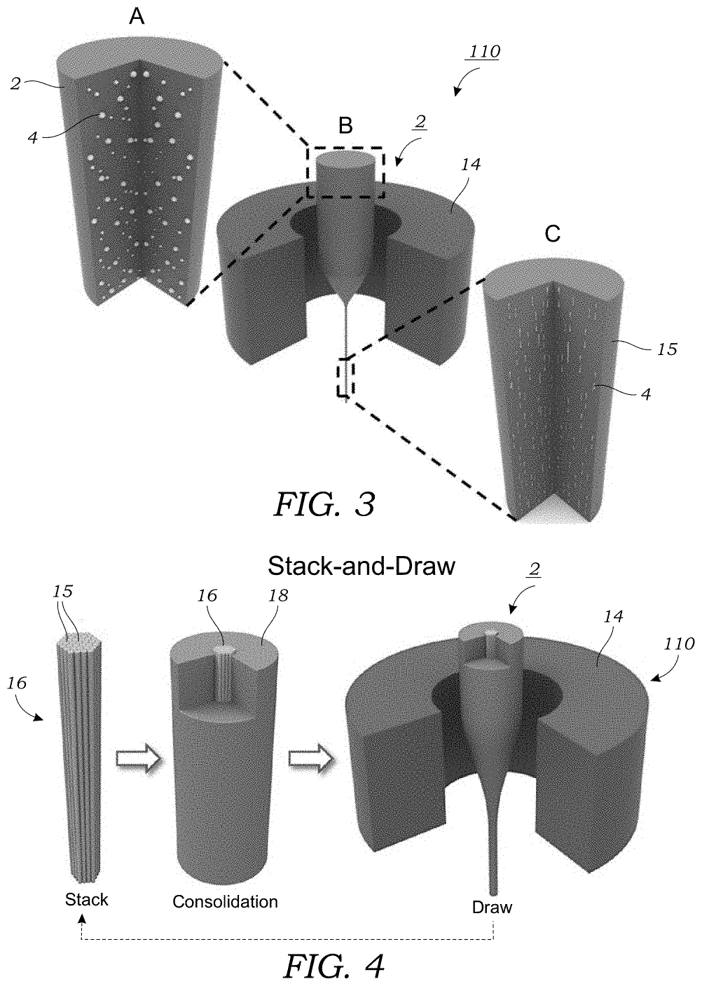

FIG. 3 illustrates partial cutaway views of a first cycle of the thermal drawing operation 110. The preform 2 is drawn through the furnace 14 to form the fiber 15. As seen in magnified view A which is taken from the non-drawn portion of the preform 2 identified area B, the embedded metal particles 4 have a large size inside the polymer matrix of the preform 2. After being drawn through the furnace 14, the metal particles 4 transform into much smaller metal particles 4, which according to one preferred embodiment, are nanometer-sized metal particles 4.

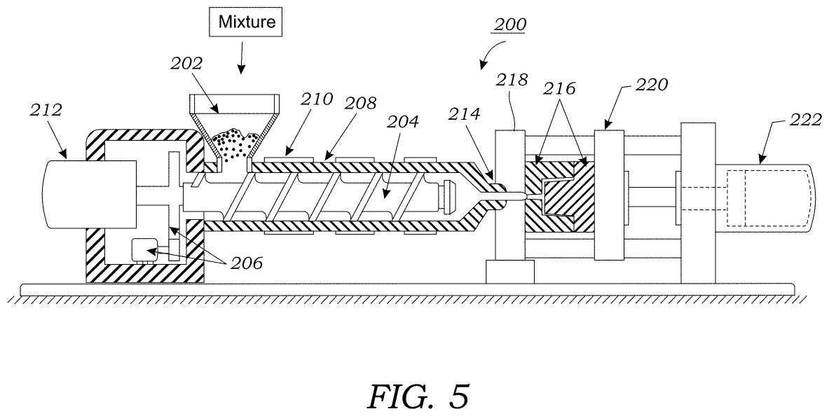

FIG. 5 illustrates another embodiment of the invention in which a polymer-metal nanocomposite material is molded using an injection molding system 200. In this embodiment, the mixture containing the metal particles 4 and the polymer particles 6 is loaded into the hopper 202 of the injection molding system 200. The injection molding system 200 includes reciprocating screw 204 driven by a motor 206 which is contained in a barrel 208 that is surrounded by heaters 210. A hydraulic ram 212 (or a motor driven ram) in conjunction with the reciprocating screw 204 drive the melted mixture through a nozzle 214 and into a cavity formed within a mold 216. The mold 216 is formed in respective halves and is pressed between a stationary platen 218 and a moveable platen 220 using a clamping drive unit 222.

Unlike the fiber-based embodiment, in this embodiment, the mixture or blend of metal particles 4 and the polymer particles 6 (which may also include granules, pellets, or the like) of the types and sizes described herein are loaded into the hopper 202 which feeds into the barrel 208 of the injection molding system 200. The mixture is then run through the injection molding system 200 whereby the polymer particles 6 and the metal particles 4 are heated and forced through the nozzle 214 and into the mold that defines the article of manufacture 60 that is formed from the molded polymer-metal nanocomposite material. In one preferred embodiment, the material in the final molded article has substantially uniform dispersion of metal particles 4 having sizes less than 1 μm.

Note that in either the thermal drawing method or the injection molding method, the manufacturing method purposefully creates thermal capillary instability so that any wires or fibers of metal that form in the polymer matrix during thermal drawing or passage through the nozzle 214 are broken to form droplets which then solidify into the smaller nanoparticles of metal.

### Example #1—Tin (Sn) and Polyethersulfone (PES)

Composite Preform Fabrication

Non-uniform Tin (Sn) and Polyethersulfone (PES) microparticles with an average diameter of 40 μm and 60 μm, respectively, were used. The PES (95 vol. %) and Sn (5 vol. %) microparticles were first blended by a mechanical shaker for one hour. The well-blended microparticle mixture was then added to a cylindrical stainless steel mold as seen in FIG. 2 with an outer diameter (OD) of 31.75 mm, an inner diameter (ID) of 19.05 mm, and a height of 152.4 mm. A hydraulic press was used to compact the well-blended microparticle mixture at room temperature. An electric furnace was then used to sinter the compacted powders at 260° C. for one hour to form a solid preform of PES-5Sn composite (where “5” refers to 5% Sn on a volume basis).

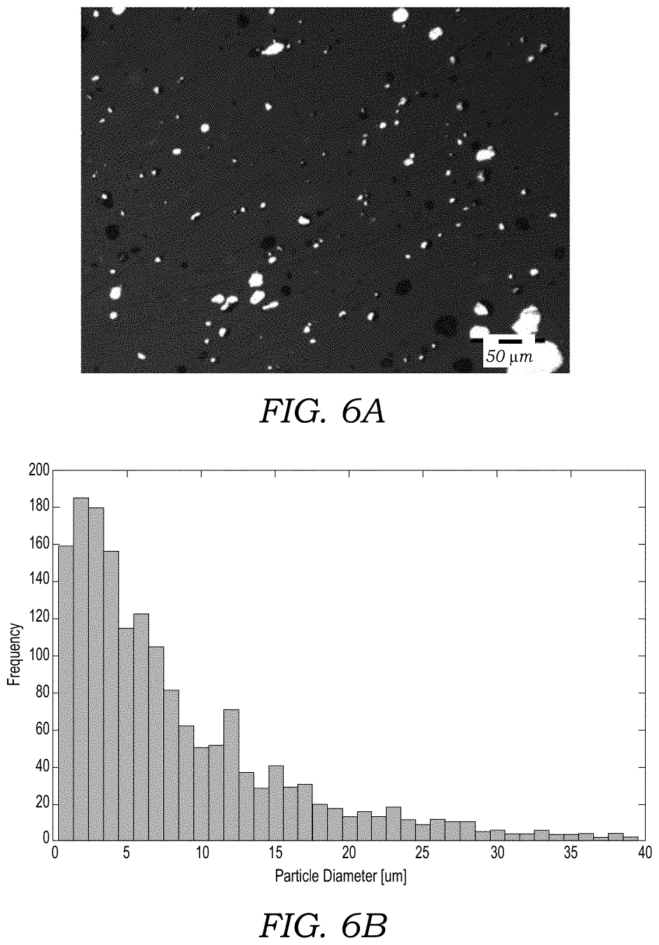

A longitudinal cross-section of the PES-5Sn composite perform was used to study the distribution and dispersion of Sn microparticles. FIG. 6A shows a typical optical microscope image from the longitudinal cross-section of the PES-5Sn composite preform. The size distribution of the micrometer-sized Sn particles in the initial preform for comparison purposes is shown in FIG. 6B.

With reference to FIGS. 1A and 4, multiple cycles of thermal fiber stack-and-draw operations were carried out to shape the embedded Sn micro-particles of random sizes into first microfibers and then finally into nanoparticles. FIG. 3 schematically represents a first cycle of the thermal drawing process. In the first thermal drawing cycle, the PES-5Sn composite preform with a diameter of 19.05 mm (represented by expanded view A in FIG. 3) was thermally drawn through a furnace down to a long (>10 m) composite fiber with an average diameter of 500 μm under the drawing parameters as listed in Table 1.

TABLE 1
Parameters for thermal fiber drawing (PES-5Sn)

| Temperature | Feeding speed | Pulling speed | Initial diameter |
|---|---|---|---|
| (° C.) | (mm/s) | (mm/s) | (mm) |
| 300 | 0.01 | 10 | 19.05 |

Next, a stack-and-draw process was used as illustrated in FIGS. 1A and 4 to iteratively form smaller-sized metal particles. With reference to FIG. 4, the composite fiber that was formed from the first thermal drawing cycle was cut into a plurality of fibers and bundled together. These cut fiber segments where then stacked together as illustrated and inserted into a cylindrical PES cladding or jacket with dimensions of 19.05 mm in OD, 3.8 mm in ID, and 8 cm in length to form the preform for the second drawing cycle preform. The newly formed perform was then consolidated in a separate tube furnace. The consolidation process heats the bundled fibers and the outer cladding to form a unitary preform structure (e.g., a next preform) than can then be used in another thermal drawing process as illustrated in the drawing process of FIGS. 1A and 4. The preform for the third thermal drawing cycle was fabricated following the same stack-and-draw procedure illustrated in FIGS. 1A and 4. That is to say, another preform is formed using the stacked segments of fibers that were created during the second thermal drawing process. These stacked fibers are then inserted into another cylindrical PES cladding or jacket and consolidated in the tube furnace. The third, solid preform structure is then ready to be drawn through the furnace as explained herein. The second and third cycles of thermal fiber drawings were carried out under the same conditions as in the first cycle as seen with the parameters of Table 1 above).

While this specific embodiment utilized three thermal drawing cycles it should be appreciated that fewer or more cycles may be used. For example, if larger sized particles or fibers embedded within a matrix are desired, there may only need to be one or two thermal draw cycles. In contrast, if smaller, nanometer-sized particles are desired, three or more thermal draw cycles may be used.

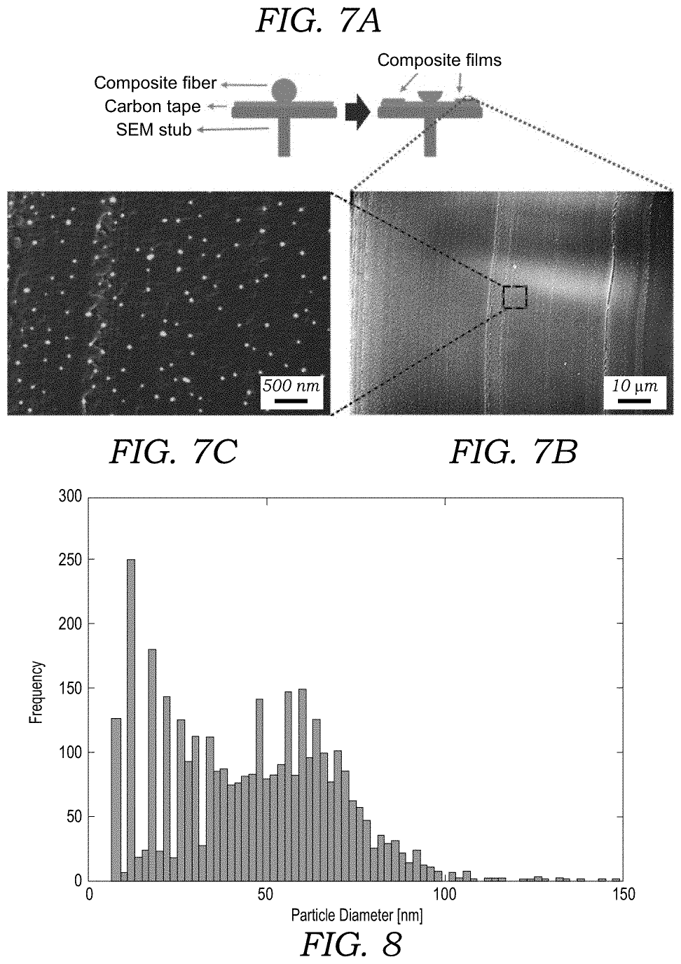

After the third drawing cycle, an ultramicrotome technique was used to prepare films for scanning electronic microscopy (SEM) analysis having a 500 nm thickness from the composite fiber's sidewall. The films were manually placed on carbon tape for SEM study as seen in the test setup of FIG. 7A. FIG. 7B illustrates a magnified view of composite fiber obtained. FIG. 7C illustrates a magnified view of the square region of FIG. 7B. FIG. 7C shows a uniform distribution and dispersion of Sn nanoparticles (light spots) throughout the PES matrix (dark background). The Sn nanoparticle sizes were measured from seven (7) different fiber samples. More than 3,500 measurements were conducted to statistically determine the average size of the Sn nanoparticles. FIG. 8 illustrates a histogram of Sn particle size. The average particle size was determined to be 46 nm.

PMNCs with uniform dispersion of metallic nanometer-sized particles embedded in a matrix can be used in a number of applications. For example, these materials may be used for electromagnetic interface shielding and electrostatic dissipation. Most of the current techniques to manufacture PMNCs are focused on bottom-up approach which is restricted for small batch fabrication. However, this method is a top-down manufacturing approach which allows scalable production of PMNCs. In addition, because PMNC composites are manufactured from thermoplastic materials, these fibers (or molded articles) can be used to produce any geometrical shapes. Finally, the manufacturing method described herein can be used for scalable fabrication of metal microparticles (e.g., micrometer-sized particles) and nanoparticles (e.g., nanometer-sized particles), if the polymer cladding is dissolved after the drawing cycle. For example, experiments show that Sn nanoparticles with average diameter of 46 nm and as small as 10 nm can be produced when PES cladding is dissolved away from the third cycle drawing fibers.

While embodiments of the present invention have been shown and described, various modifications may be made without departing from the scope of the present invention. The invention, therefore, should not be limited, except to the following claims, and their equivalents.

1. A method of forming a polymer-metal nanocomposite (PMNC) material with a substantially uniform dispersion of metal particles comprising:
a) forming a composite solid preform by mixing a blend of micrometer-sized metal particles and polymer particles and subjecting the mixture to compression followed by sintering;
b) drawing the composite solid preform of (a) through a heated zone to form a reduced size fiber;
c) cutting the reduced size fiber into segments and forming a next preform using the bundle of the segments; and
d) drawing the next preform through the heated zone to form another reduced fiber.

2. The method of claim 1, further comprising repeating operations (c) and (d) a plurality of times to form a final fiber.

3. The method of claim 1, wherein the bundle of segments is contained within cladding.

4. The method of claim 1, wherein the cladding comprises a thermoplastic polymer.

5. The method of claim 4, wherein the cladding is formed from the same polymer as the polymer particles.

6. The method of claim 3, wherein the cladding comprises one of polyethersulfone (PES), polysulfone (PSU), and polyethylenimine (PEI), glass, and fused silica.

7. The method of claim 1, wherein the metal particles comprise a metal selected from the group consisting of tin, bismuth, indium, silver, gold, copper, zinc, or any alloy of the same.

8. The method of claim 1, wherein the polymer particles comprise one of polyethersulfone (PES), polysulfone (PSU), and polyethylenimine (PEI), glass, and fused silica.

9. The method of claim 2, wherein the final fiber comprises nanometer sized metal particles dispersed therein in a substantially uniform manner.

10. The method of claim 1, wherein the micrometer-sized particles of metal comprise tin (Sn) and the particles of polymer comprise polyethersulfone (PES).

11. The method of claim 1, wherein the blend comprises 95% (by volume) PES and 5% Sn (by volume).

12. The method of claim 11, wherein the blend is loaded into a heated mold and compacted with a press.

13. The method of claim 12, wherein sintering comprises heating the compacted blend at a temperature of about 260° C. for about one hour to form a solid composite preform.

14. The method of claim 1, wherein the composite preform comprises a solid comprising less than 40% by volume of metal.

15. The method of claim 2, wherein the final fiber contains nanometer sized metal particles dispersed substantially uniformly therein.

16. A polymer-metal nanocomposite fiber having metal particles dispersed substantially uniformly therein produced using the method of claim 1.

17. A polymer-metal nanocomposite fiber having nanometer-sized metal particles formed within a polymer matrix and dispersed substantially uniformly therein, wherein the polymer-metal nanocomposite fiber is formed by drawing a metal/polymer composite preform having micrometer sized metal particles formed in a polymer matrix through a heated zone a plurality of times using stack-and-draw process.

18. A method of forming a molded polymer-metal nanocomposite material with a substantially uniform dispersion of metal particles comprising:
forming a blend of metal particles having a size range from 1 μm to several millimeters and polymer particles, wherein the metal particles have a melting temperature less than a decomposition temperature of the polymer; and
subjecting the blend to injection molding to generate the molded polymer-metal nanocomposite material, wherein the molded polymer-metal nanocomposite material has substantially uniform dispersion of metal particles having sizes less than 1 μm.

19. A polymer-metal nanocomposite fiber having metal particles dispersed substantially uniformly therein produced using the method of claim 2.
